(19) United States
(12) Patent Application Publication
(10) Pub. No.: US 2010/0329758 A1
(43) Pub. Date: Dec. 30, 2010

(54) SHEET SUPPLYING DEVICE, IMAGE FORMING APPARATUS, AND IMAGE FORMING SYSTEM USING THE SAME DEVICE

(76) Inventors: Kazutoshi YOSHIMURA, Tokyo (JP); Kenji YAMAMOTO, Tokyo (JP); Kazumichi YAMAUCHI, Tokyo (JP); Hideki NAKAMURA, Tokyo (JP); Akira OKAMOTO, Tokyo (JP); Masatoshi OGAWA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/818,903

(22) Filed: Jun. 18, 2010

(30) Foreign Application Priority Data
Jun. 24, 2009 (JP) JP2009-150191

(51) Int. Cl. G03G 15/00; B65H 5/22; B65H 7/02

(52) U.S. Cl. 399/388; 271/5; 271/265.02

(57) ABSTRACT

A sheet supplying device, including a sheet accommodating section which accommodates recording sheets, and is removable from a main body of the sheet supplying device, a locking section which locks the sheet accommodating section within the main body, not to draw out the sheet accommodating section from the main body, a suction conveying section which vacuums the recording sheet accommodated in the sheet accommodating section and conveys the recording sheet, and a suction detecting section which detects the recording sheet vacuumed by the suction conveying section, wherein when the suction conveying section has supplied the recording sheet, if the suction detecting sensor detects the recording sheet, the locking section locks the sheet accommodating section within the main body of the sheet supplying device, and if it does not detect the recording sheet, the locking section releases the sheet accommodating section from the main body.

### CROSS REFERENCE TO RELATED APPLICATION

This application is based on Japanese Patent Application No. 2009-150, 191 filed on Jun. 24, 2009 with the Japanese Patent Office, the entire content of which is hereby incorporated by reference.

### TECHNICAL FIELD

The present invention relates to a sheet supplying device which is used on image forming apparatuses, such as copying machines, printers, facsimile devices, printing machines, and compound machines, an image forming apparatus which uses the above described sheet supplying device, and an image forming system which includes the sheet supplying device and the image forming apparatus, and in particular, the present invention relates to technologies for vacuuming and conveying sheets to be used for image forming operations.

### BACKGROUND TECHNOLOGY

The sheet supplying device is provided on the image forming apparatus, and plural recording sheets are stacked on a tray of the sheet supplying device, whereby a sheet is individually conveyed from the tray to an image forming section. If plural recording sheets are conveyed at the same time, the image forming apparatus jams. If the force to convey the recording sheet is small, the recording sheet cannot be exactly conveyed, which results in an adverse conveying operation.

Accordingly, various technologies are used in the sheet supplying device to exactly convey the recording sheets one by one. For example, when the frictional factor is increased between the recording sheet and a sheet-supplying roller, an uppermost recording sheet stacked on the tray can be exactly conveyed.

Further, to prevent the plural recording sheets from being conveyed at the same time, often used are a sheet separation roller, a sheet separation pad, and a sheet separation claw, which thrust back the second or subsequent sheets, and the uppermost sheet only can be conveyed.

As an exact method to convey a single recording sheet from the sheet supplying device to the image forming apparatus, a vacuuming section, mounted above the sheet supplying tray, is activated to vacuum a recording sheet upward, and said recording sheet is conveyed by a suction belt, whereby the uppermost recording sheet can be conveyed. Further, to prevent plural recording sheets from being conveyed at the same time, an air blowing section is configured to blow air against the sides of the recording sheets, so that the uppermost recording sheet is separated from the second or subsequent recording sheets. By such sheet supplying device, only a single recording sheet is exactly conveyed to the image forming apparatus.

However, when the above sheet supplying device is employed, after the image formation and the sheet supplying operation are completed, after several times have passed, an air suction force still remains in the suction section, so that the recording sheet has been still vacuumed.

Under the above condition, since the image formation and the sheet supplying operation have been completed, the operator may draw out the sheet supplying tray, though the operator does not know the vacuumed sheet. In this case, if the operator draws out the sheet supplying tray, an abnormal force is applied against the vacuumed sheet, whereby a suction detecting sensor, which functions to detect the suction condition of the suction section, and the suction belt receive abnormal forces, so that the suction detecting sensor and the suction belt may be adversely affected. Further, when the sheet supplying tray is drawn out, the vacuumed sheet may be also damaged, so that said sheet cannot be used again.

The above described sheet supplying device and image forming apparatus are disclosed in the patent documents below.

Patent Document 1: Unexamined Japanese Patent Application Publication H03-117, 551;

Patent Document 2: Unexamined Japanese Patent Application Publication 2002-321, 834;

Patent Document 3: Unexamined Japanese Patent Application Publication 2005-132, 514; and

Patent Document 4: Unexamined Japanese Patent Application Publication 2006-89, 153.

Patent Document 1 discloses that a drawing operation of the tray is prohibited while the image formation, because the image may be damaged, or any mechanical parts may be damaged. However, the drawing operation, just after the image formation, is not taught.

Patent Document 2 discloses that when the tray is to be drawn out while a recording sheet has been vacuumed, a claw is provided to remove said recording sheet, and the removed recording sheet is sent to a tray. Since several mechanical parts are necessary to structure this method, the production cost adversely increases. Further said claw may damage the thin recording sheets, or soft recording sheets, while removing them.

Patent Document 3 discloses that when a tray is to be drawn out while a recording sheet has been vacuumed, a lever is provided to remove said recording sheet, and air is blown against the vacuumed recording sheet. Since several mechanical parts are necessary to structure this method, and an air blowing mechanism is also necessary, the production cost adversely increases.

Patent Document 4 discloses that when the tray is to be drawn out while a recording sheet has been vacuumed, a shutter is provided within an air duct of the suction section, and said shutter is driven to close the air duct so that said recording sheet falls. Since several mechanical parts, including the shutter, are necessary to structure this method, the production cost adversely increases.

### SUMMARY OF THE INVENTION

A sheet supplying device reflecting one aspect of the present invention comprises a sheet accommodating section which is configured to accommodate recording sheets, and is removable from a main body of the sheet supplying device, a locking section which is configured to lock the sheet accommodating section within the main body of the sheet supplying device, so that the sheet accommodating section is not drawn out from the main body of the sheet supplying device, a suction conveying section which is configured to vacuum the recording sheet accommodated in the sheet accommodating section and conveys the recording sheet, and a suction detecting section which is configured to detect the recording sheet which has been vacuumed by the suction conveying section, wherein when the sheet supplying section has supplied a sheet, if the suction detecting sensor detects the recording sheet, the locking section locks the sheet accommodating section within the main body of the sheet supplying device, and if the suction detecting sensor does not detect a recording sheet, the locking section releases the sheet accommodating section from the main body of the sheet supplying device.

Further, the present invention comprises an image forming apparatus including, the above detailed sheet supplying device, and an image forming section which is configured to form an image on the recording sheet which has been supplied from the sheet supplying device.

Still further, the present invention comprises an image forming system including, an image forming apparatus which is configured to form an image on a recording sheet, a sheet supplying device which is configured to supply the recording sheet to the image forming apparatus, and a control section which is configured to control the image forming apparatus and the sheet supplying device, wherein the sheet supplying device includes a sheet accommodating section which is configured to accommodate recording sheets, and is removable from the main body of the sheet supplying device, a locking section which is configured to lock the sheet accommodating section within the main body of the sheet supplying device, so that the sheet accommodating section is not drawn out from the main body of the sheet supplying device, a suction conveying section which is configured to vacuum the recording sheet accommodated in the sheet accommodating section and conveys the recording sheet, and a suction detecting section which is configured to detect a recording sheet which has been vacuumed by the suction conveying section, and when the sheet supplying section has supplied the sheet, the control section controls the locking section in such a way that if the suction detecting sensor detects a recording sheet, the locking section locks the sheet accommodating section within the main body of the sheet supplying device, and if the suction detecting sensor does not detect a recording sheet, the locking section releases the sheet accommodating section from the main body of the sheet supplying device.

### BRIEF DESCRIPTIONS OF THE DRAWINGS

Embodiments will now be detailed, by way of example only, with reference to the accompanying drawings which are meant to be exemplary, not limiting, and wherein like embodiments are numbered alike in the several figures, in which:

FIG. 1 is a block diagram to show a structure of an embodiment of the present invention;

FIG. 2 is a cross-sectional view to show the structure of the embodiment of the present invention;

FIG. 3 is a flow chart to show operations of the embodiment of the present invention;

FIG. 4 is a perspective view to show the structure of the embodiment of the present invention;

FIG. 5 is a side view of the sheet supplying device of the present invention; and

FIGS. 6a and 6b show air flow operations of the embodiment of the present invention.

### DETAILED DESCRIPTIONS OF THE PREFERRED EMBODIMENTS

The present embodiments will now be detailed while referring to the drawings.

### [Structure]

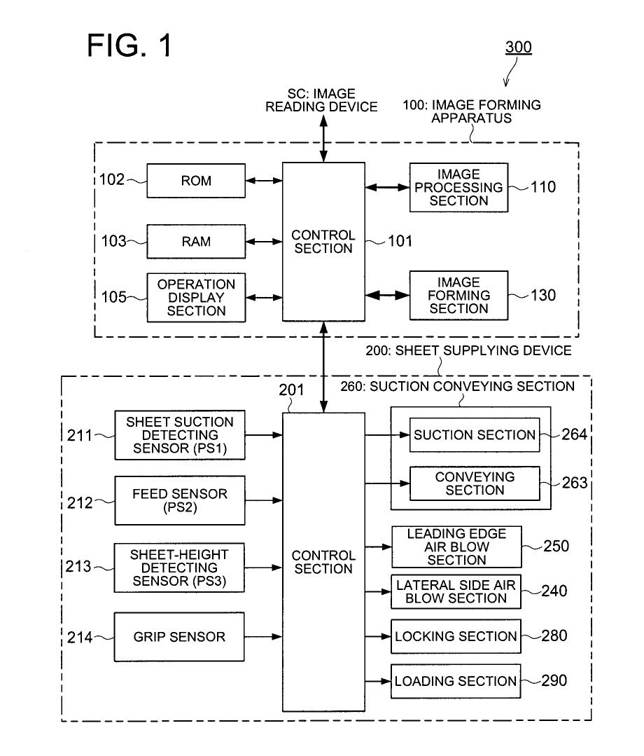

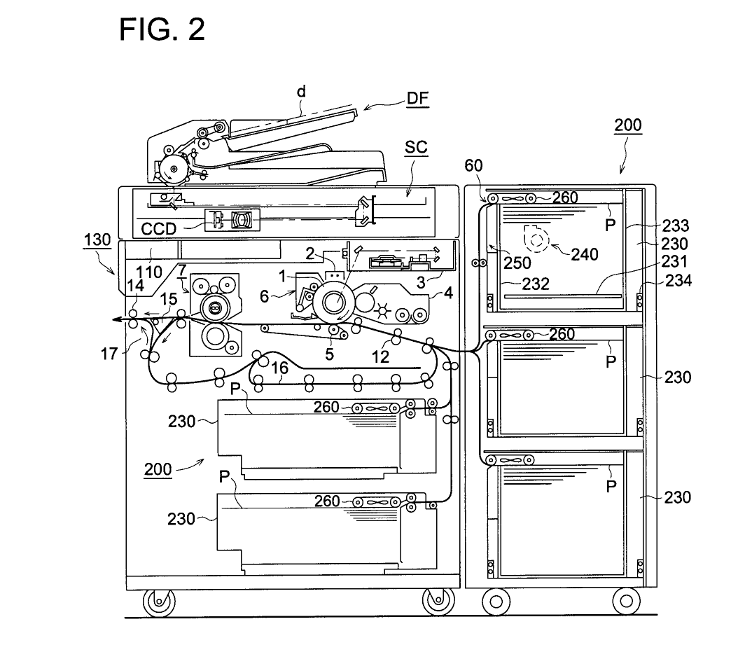

Image forming system 300 relating to Embodiment 1 will now be detailed while referring to FIGS. 1 and 2.

Image forming system 300 can be applied on various systems, however, a system will now be detailed, combining a sheet supplying device with an image forming apparatus, serving as a compound apparatus (being an MFP), including the functions of a scanner, a copying machine, a printer, and a facsimile device.

Various matters, being well-known matters as the sheet supplying devices and image forming apparatus, are omitted from the explanations, and various matters, which do not relate to the operations and the controls of the present embodiments, are also omitted from the explanations. FIG. 1 shows image forming system 300 in which image forming apparatus 100, as the present embodiment, is combined with sheet supplying device 200.

Image forming apparatus 100, as the present embodiment, is structured of control section 101 serving as a total control section to control each section, ROM (being Read Only Memory) 102 to store various data and programs, RAM (being Random Access Memory) 103 in which various programs are memorized, operation display section 105 to display operations inputted by the operator, image processing section 110 which processes the image data, and image forming section 130 which forms an image, based on the processed image data.

Sheet supplying device 200 is structured of control section 201 which controls each section of sheet supplying device 200, sheet suction detecting sensor 211 which detects the vacuuming condition of the recording sheet in suction conveying section 260, feed sensor 212 which detects the conveying condition of the recording sheet in suction conveying section 260, sheet-height sensor 213 which detects the height of the recording sheets stacked in the tray, so that the recording sheets stacked in the tray can be kept at an optimum height to be vacuumed, grip sensor 214 which detects the gripped condition of a grip section which is gripped by the operator to draw out a sheet accommodating section from the main body of sheet supplying device 200, lateral side air blow section 240 which helps suction section 264 to vacuum the uppermost recording sheet, and helps the second and subsequent recording sheets to fall downward, leading edge air blow section 250 which blows air against the leading edges of the second and subsequent recording sheets, so as to separate from each other and to fall downward, whereby a double sheets feeding is prevented, suction conveying section 260, including suction section 264 which vacuums the recording sheet stacked in the tray, and conveying section 263 which conveys the recording sheet vacuumed by suction section 264, locking section 280 which locks the sheet accommodating section, being able to be drawn out, within the main body of sheet supplying device 200, so that the sheet accommodating section cannot be drawn out, and loading section 290 which inserts and draws out the sheet accommodating section by a force generated by a motor. In addition, for the manual operation of the sheet accommodating section, loading section 290 can be omitted.

FIG. 2 is a cross-sectional view to show image forming apparatus 100, combined with sheet supplying device 200. Image forming apparatus 100 is structured of image reading section SC which reads the images carried on an original document, automatic document feeding section DF which automatically conveys the original document to image reading section SC, image forming section 130 which forms a toner image on the recording sheet, sheet supplying device 200, and sheet supplying device 200′ included in image forming apparatus 100.

Image forming section 130, illustrated in FIG. 2, is structured of photoconductive body 1, serving as an image carrier, electro-charging section 2, exposure device 3, developing device 4, transfer section 5, cleaning section 6, and fixing device 7.

A recording sheet conveying section is structured of second sheet-supplying section 12, sheet ejection section 14, conveying path changing section 15, circulation sheet re-supplying section 16, and reversing sheet ejection section 17.

Original document “d”, placed on a platen of automatic document feeding section DF, is conveyed by the sheet supplying section, so that the images, carried on the front surface or the reverse surface of original document “d”, are exposed by an optical system of image reading section SC, to be read out by image sensor CCD. Analog signals, which have been photo-electrically converted by image sensor CCD, are processed at image processing section 110, with respect to an analog process, an A/D conversion, a shading correction, and an image compression process. The processed signals are sent to exposure device 3 as the image signals.

In a case of the image formation using an electro-photographic method, various processes, such as the electrical charging process, exposure process, developing process, transferring process, sheet separating process, and cleaning process, are conducted in image forming section 130. In the image forming process, the surface of photoconductive body 1 is electrically charged by charging section 2, after that, exposure device 3 radiates laser rays onto said surface, so that electrostatic latent images are formed, developing device 4 subsequently develops said electrostatic latent images, so that toner images are formed on said surface. After that, recording sheet P, accommodated in sheet supplying device 200 or sheet supplying device 200′, is conveyed. Recording sheet P is conveyed by second sheet supplying section 12, structured of paired registration rollers, while sheet P is synchronized with the toner images which are formed on the surface of photoconductive body 1. After that, the toner images are transferred onto sheet P by transfer section 5, the toner images, transferred onto sheet P, are subsequently fixed by fixing device 7.

After that, sheet P, carrying the fixed images, is ejected to the exterior of image forming apparatus 100 by sheet ejection section 14. At the same time, the toner particles, remaining on the surface of photoconductive body 1, are removed by cleaning section 6. In a case of the double-surfaces image formation, sheet P, carrying the formed image on its front surface, is conveyed to circulation sheet re-supplying section 16, so that sheet P is reversed, after that, sheet P is conveyed to image forming section 130, where the image is formed on the reverse surface, and sheet P, carrying the images on both surfaces, is ejected to the exterior of image forming apparatus 100. If sheet P is reversed to be ejected, after sheet P is directed to another path from a common path, sheet P is switched-back, so that sheet P is reversed, whereby sheet P is ejected to the exterior of image forming apparatus 100.

Sheet supplying device 200, relating to the present embodiment, is structured so that it can be separated from image forming apparatus 100, whereby said sheet supplying device 200 is combined with image forming apparatus 100. Further, sheet supplying device 200′, relating to the present embodiment, is combined with image forming section 130 within image forming apparatus 100.

Sheet supplying device 200 or 200′, including sheet accommodating section 230, lateral side air blow section 240, leading edge air blow section 250, and suction conveying section 260, can accommodate a great number of recording sheets P, whereby sheet supplying device 200 or 200′ vacuums sheets P one by one, and supplies sheet P to image forming apparatus 100, or image forming section 130, respectively.

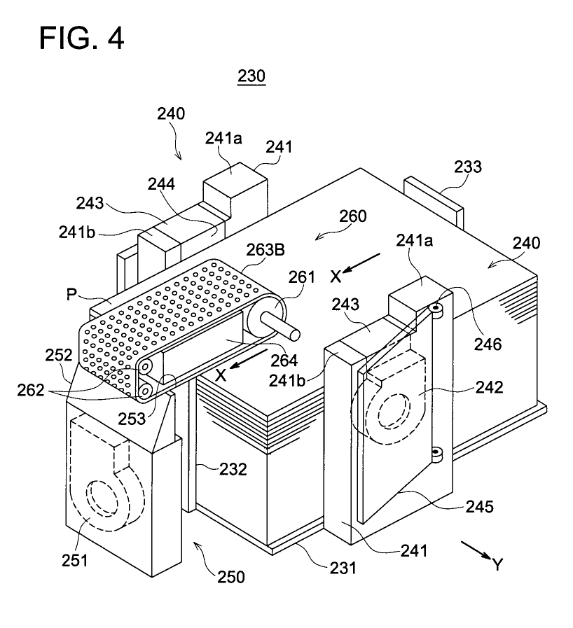

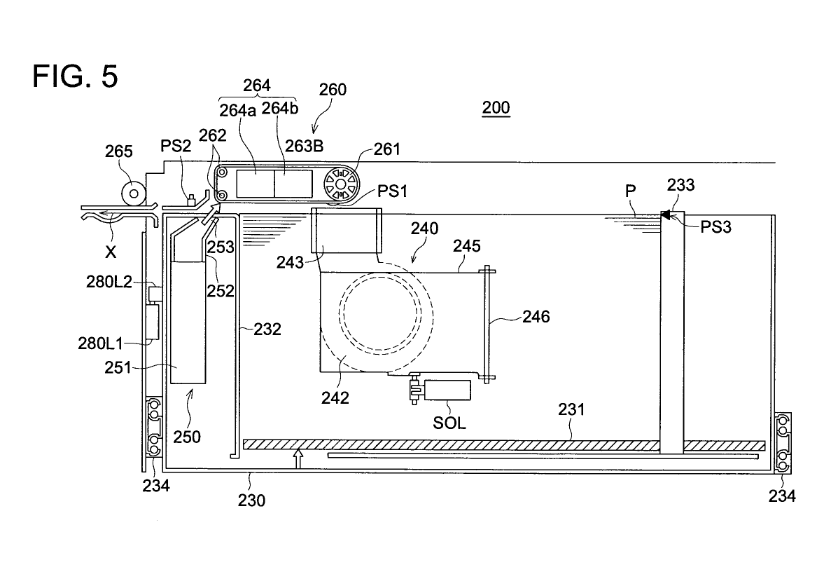

FIG. 4 is a perspective view to show the internal structure of sheet accommodating section 230, being a relevant section of sheet supplying device 200 of the present embodiment, and FIG. 5 is a side view of sheet supplying device 200. As shown in FIGS. 4 and 5, sheet accommodating section 230 includes sheet supplying tray 231, leading edge aligning member 232, trailing edge aligning member 233 and guide rails 234.

Sheet accommodating section 230 can be drawn out or inserted into a covering box section of sheet supplying device 200, by guide rail 234, in direction Y shown in FIG. 4, or in the depth direction of FIG. 5. Accordingly, to accommodate sheets P in sheet supplying tray 231, sheet accommodating section 230 is drawn out from sheet supplying device 200.

Further, as shown in FIG. 5, locking section 280L1 of the covering box section of sheet accommodating section 230 can be engaged to locking section 280L2 of sheet accommodating section 230, based on an instruction sent from control section 201, whereby sheet accommodating section 230 cannot be drawn out by the operator during the image forming operation. Locking sections 280L1 and 280L2 are configured to structure locking section 280, shown in the block diagram of FIG. 1.

In FIG. 2, sheet accommodating sections 230, serving as sheet supplying device 200, are vertically stacked to be three sections. Also in FIG. 2, sheet supplying sections 230, serving as sheet supplying device 200′ included within image forming apparatus 100, are vertically stacked to be two sections.

Plural sheets P, stacked on sheet supplying tray 231, can be elevated by a mechanism, which is not illustrated. Lateral side aligning member 241 is configured to move in the lateral direction of sheet P, so that lateral side aligning member 241 softly pushes the lateral sides of the stacked sheets to control the lateral position of stacked sheets P.

In FIG. 4, lateral side aligning member 241 has two top surfaces, wherein top surface 241b, existing downstream in the supplying direction of sheet P, is lower than top surface 241a, existing upstream in the supplying direction of sheet P. A supporting member, which is not illustrated, to support the top of lateral side aligning member 241 is mounted on top surface 241a. Top surface 241b, existing downstream side, is to be overlapped with suction conveying section 260 in the sheet supplying direction (which is shown by arrows X in FIGS. 4 and 5), which will be detailed later. That is, when sheet supplying tray 231 is drawn out in arrowed direction Yin FIG. 4, top surface 241b can move under suction conveying section 260.

Leading edge aligning member 232 aligns the leading edges of Sheets P in the sheet supplying direction. Trailing edge aligning member 233, which is movable in the sheet supplying direction, aligns the trailing edges of sheets Pin the sheet supplying direction.

In FIG. 5, height sensor PS3, which detects the height of uppermost sheet P, is mounted on trailing edge aligning member 233. In order to keep the optimum height to blow air and to blow air against recording sheets P, control section 201 controls a motor, which is not illustrated, to elevate sheet supplying tray 231, based on the result of height sensor PS3.

As shown in FIG. 5, suction conveying section 260 is arranged in the vicinity of the leading edge of sheet P stacked on tray 231. Suction conveying section 260 includes suction belt 263B, serving as conveying section 263, which is entrained about large roller 261, being connected to a driving source, and two small rollers 262. Plural small holes are provided to penetrate suction belt 263B. Suction section 264, serving as a suction section, is arranged within suction belt 263B, whereby sheet P is vacuumed by suction section 264 through suction belt 263B, and is conveyed to sheet supplying roller 265.

As shown in FIGS. 4 and 5, lateral side air blow sections 240 are arranged at both sides of tray 231, whereby air is blown in the direction perpendicular to the conveying direction of sheet P, against the top portion of stacked sheets P accommodated in tray 231. Each lateral side air blow section 240 includes air blow fan 242 to blow air against the top portion of stacked sheets P, through air outlet 244, arranged to be perpendicular to the conveying direction of sheet P. Air outlet 244 is arranged on surface 241b, being the downstream surface of side surface lateral side aligning member 241, in the recording sheet conveying direction (which is shown by arrow X) whereby at least a portion of air outlet 244 overlaps suction conveying section 260. That is, in FIG. 5, a top portion of air outlet 244 is illustrated under suction belt 263B.

Since lateral side air blow section 240 is arranged within lateral side aligning member 241, even when the size of sheet P is changed for use, lateral side aligning member 241 can be moved to a new position with lateral side air blow section 240. In addition, lateral side air blow sections 240 are arranged at both sides of stacked sheets P in this embodiment, but can be arranged at a single side.

When lateral side air blow section 240 is activated, air is blown against the lower portion of suction conveying section 260 through air outlet 244, whereby air is blown against the several upper sheets of stacked sheets P. Said air passes through sheets P from one side to the other side. Accordingly, the several upper sheets can be separated one by one, and suction conveying section 260 vacuums only uppermost sheet P.

Suction detecting sensor PS1, mounted adjacent to the suction surface of suction belt 263B, detects that the uppermost sheet P has been vacuumed onto suction belt 263B. Suction belt 263B begins to rotate, and conveys recording sheet P. Feed sensor PS2, mounted in adjacent to suction belt 263B, being downstream in the sheet conveying direction of sheet tray 231, detects that a conveyed recording sheet P passed through feed sensor PS2.

In FIG. 4, leading edge air blow section 250 is mounted on accommodating section 230, so as to face the leading edges of the recording sheet being conveyed in arrowed direction X by suction conveying belt 263B. Leading edge air blow section 250 is structured of air blowing fan 251 or the like. As another method, leading edge air blow section 250 is mounted on accommodating section 230, so that air can be blown to the leading edges of the recording sheets through an air duct. Air blowing fan 251 is mounted with its air outlet 253 facing upward. The direction of air being blown upward from air fan 251 is changed by guide plate 252, and said air is blown obliquely upward through air outlet 253, so that said air is blown against suction conveying belt 263B of suction conveying section 260. Driving of leading edge air blow section 250 is controlled, based on types of recording sheets P, such as OHP sheets, tracing sheets, flat and smooth coated printing sheets, perforated recording sheets, sheets with folding lines, and floured sheets carrying offset prints. When any one of these sheets are used, the sheets can be exactly separated from each other by blown air.

When suction conveying belt 263B, vacuuming uppermost recording sheet P, is rotated, said sheet P is conveyed in arrowed direction X in FIG. 5, and then said sheet P is conveyed by sheet supplying roller 265, after that said sheet P is sent to image forming section 130.

As shown in FIGS. 4 and 5, an air inlet of lateral side air blow section 240 is closed or opened by shielding member 245. Shielding member 245, structured of a plate shutter, is pivoted by shaft 246, and is driven by solenoid SOL. Control section 101 controls shielding member 245 to open and close, so that air flow can be blown or shielded.

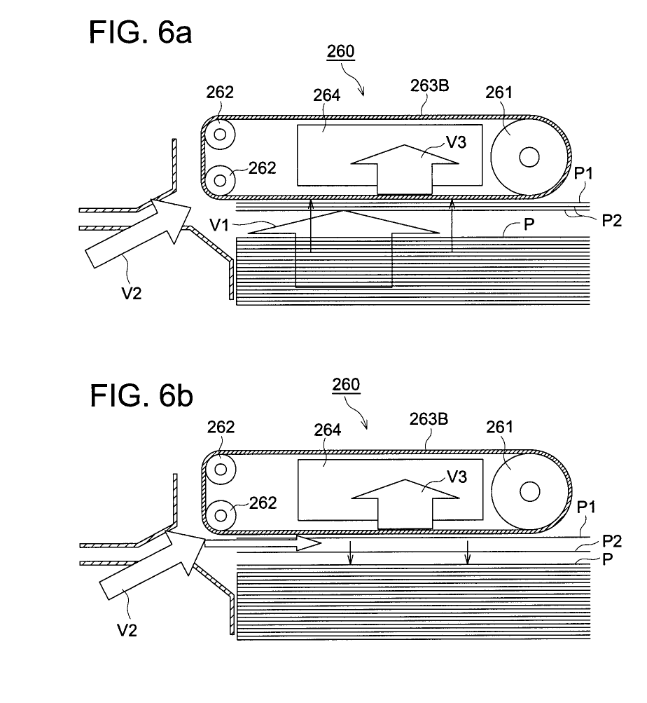

FIG. 6 is a cross-sectional view showing the suction conveying operation conducted by lateral side air blow sections 240 and leading edge air blow section 250. FIG. 6a shows the air suction operation. Lateral side air flow V1 is generated by lateral side air blow section 240, and is blown against the lateral sides of recording sheets P stacked on tray 231, so that several upper stacked sheets P are floated against gravity, whereby said several sheets P are vacuumed by suction air flow V3, being negative pressure generated within suction belt 263B. Leading edge air flow V2 is generated by leading edge air blow section 250, and is blown between the leading edges of vacuumed sheets P and suction belt 263B.

FIG. 6b shows the separating operation of stacked recording sheets P. After several of the upper sheets of stacked recording sheets P are vacuumed by suction belt 263B, shielding member 245 is driven to close the air inlet of lateral side air blow section 240 so that lateral side air flow V1 is stopped. Only leading edge air flow V2, generated by leading edge air blow section 250, passes between the uppermost recording sheet P1 and subsequent sheet P2. Uppermost recording sheet P1 remains on the surface of suction belt 263B, while having been vacuumed by suction air flow V3, generated by suction conveying section 260, that is, only uppermost recording sheet P1 can be picked up from the stacked recording sheets P, and subsequent recording sheet P drops down by the gravity in an arrowed direction in FIG. 6b, and is stacked again on the remaining stacked recording sheets P.

Since air blowing operations, conducted by lateral side air blow section 240 and leading edge air blow section 250, are repeated, several upper recording sheets P2 are floated near the total areas of air outlets 244 and 253, so that the clearance between each recording sheet becomes nearly equal, and air passes through the clearances. Accordingly, the recording sheets are separated from each other as desired, and each recording sheet can be conveyed.

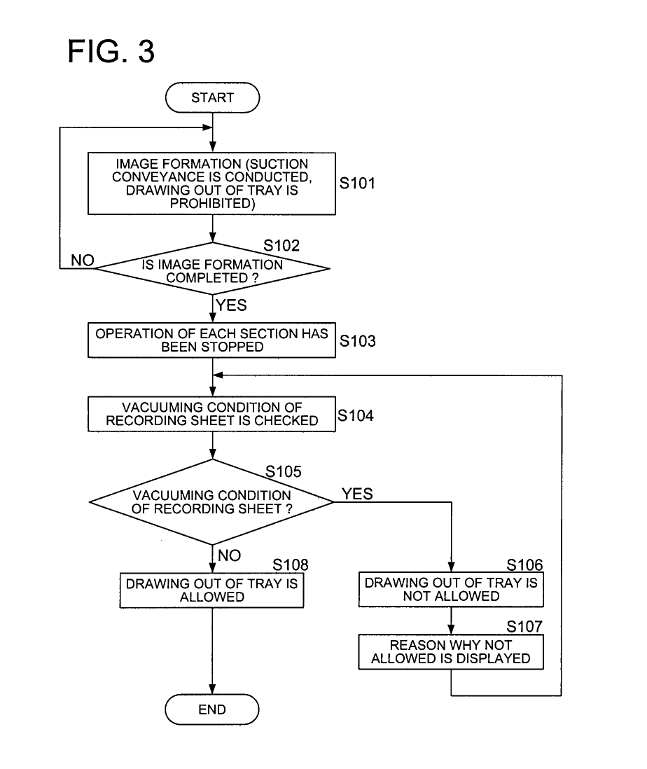

Operations of sheet supplying device 200, and image forming apparatus 100 will be explained, while referring to the flowchart shown in FIG. 3. For simpler explanations, signal communications between control section 101 and control section 201 are not explained, but control section 201 is configured to control the various sections of sheet supplying device 200, based on instructions sent from control section 101.

Working instructions of the image formations concerning the image data which is read by image reading device SC, or concerning the image data which is inputted from the external devices (which are not illustrated), are sent to image forming apparatus 100, control section 101 conducts a series of processes, such as electrical charging, exposure, development, transferring, separation, and cleaning, in image forming section 130, so that the image formation is conducted (which is shown in step S101 in FIG. 3). On such occasions, control section 101 gives the working instructions to control section 201, and sheet supplying device 200 supplies a recording sheet which is appropriate to the image formation. Sheet supplying device 200 supplies the sheets one by one, using the above detailed suction conveyance. Control section 201 controls locking section 280 (including 280L1, and 280L2) to lock accommodating section 230, so that the operator cannot draw out accommodating section 230 from the main body of sheet supplying device 200, during the image formation.

After the image formation has been completed (which is “YES” of step S102 in FIG. 3), image forming section 130 completes various operations for the image formation, in accordance with the instructions sent from control section 101 (Step S103). If necessary, any toner particles, remaining on photoconductive body 1, are removed.

After control section 101 sends information including the completed image formation, to control section 201, control section 201 controls suction section 264 to complete the vacuuming operation, further controls conveying section 263 to complete the suction conveyance, still further controls leading edge air blow section 250 to complete the air blowing operation, still further controls lateral side air blow section 240 to complete the air blowing operation (Step S103).

Though sheet supplying device 200 has completed the sheet conveyance and the air blowing operations, suction section 264 still has an air suction force, that is, a recording sheet, which was vacuumed but not conveyed, still remains on conveying section 263 (being suction belt 263B).

Control section 201 checks sheet suction sensor 211, and determines whether the recording sheet has been vacuumed onto suction belt 263B or not (step S104).

In case that plural sensors are used for suction detecting sensor 211, if detected results of said plural sensors differ, they means that the sheet vacuumed by suction belt 263B is going to falling off, so that it is possible to determine that no sheet is vacuumed. Accordingly, since a condition is detected that the sheet is going to falling off, quick counter action can be conducted.

When suction detecting sensor 211 has detected a vacuumed sheet (“YES” in step S105), control section 201 does not allow sheet accommodating section 230 to be drawn out, and controls locking section 280 to lock sheet accommodating section 230 within the main body of sheet supplying device 200 (step S106).

Since a display section or an warning lamp is provided on sheet supplying device 200, control section 201 displays information to show that sheet accommodating section 230 is prevented to be drawn out, or controls the warning lamp to give a warning by continuous light or blinking light (step S107). Further, control section 201 sends information to control section 101, showing that sheet accommodating section 230 cannot be drawn out because the sheet is still vacuumed, and said information is displayed on operation display section 105. By displayed such information, the operator can understand that unable drawing out of sheet accommodating section 230 is effectively controlled by control sections 201 and 101, so that sheet supplying device 200 can be optimally used by the operator.

Further, control section 201 again checks for detected results of suction sensor 211, whether the recording sheet has been vacuumed onto suction belt 263B (steps S104 and S105), that is, control section 201 repeats the check and displays prohibited drawing out operation of sheet accommodating section 230, until the recording sheet drops by gravity, which is a non-sheet vacuumed condition (“NO” in step S105).

When no sheet is detected by suction sensor 211 (“NO” in step S105), control section 201 controls locking section 280 to release sheet accommodating section 230, whereby sheet accommodating section 230 can be drawn out (step S108). Control section 201 clears the prohibited drawing operation of sheet accommodating section 230, displayed on the display. Or, control section 201 can display allowance of the drawing operation of sheet accommodating section 230. Further, it is possible to structure the apparatus in such a way that control section 201 sends a message to control section 101, showing that the vacuumed sheet has dropped from the belt, so that the drawing out operation of sheet accommodating section 230 is allowed, which can be displayed on operation display section 105.

As the other method, if loading section 290 is provided to electrically draw out accommodating section 230, when suction sensor 211 has detected a vacuumed sheet (“YES” in step S105), control section 201 does not allow the drawing out operation of accommodating section 230, so that locking section 280 remains under the locking condition (step S106), and control section 201 controls loading section 290 not to conduct the drawing out operation of accommodating section 230. Further, if loading section 290 is provided to electrically draw out accommodating section 230, control section 201 can display the above described message on operation display section 105, based on detected results of grip sensor 214 mounted on a grip section of accommodating section 230, besides the grip section is not illustrated.

Due to the above described structures, after the sheet supplying operation has been completed, when no sheet, vacuumed by suction conveying section 260, has been detected, locking section 280 is controlled to release accommodating section 230, so that accommodating section 230 can be drawn out. After the image forming operation has been completed, accommodating section 230 can be safely drawn out, so that the recording sheet is not damaged by the sheet separation claw, no specific member is mounted, and no waiting time is generated.

In the above embodiment, after the image forming operation has been completed, the detection of sheet vacuuming condition, and the control of allowance and prohibition of the drawing out operation can be configured to conduct for all types of recording sheets, or for predetermined types of recording sheets.

The predetermined types of recording sheets include fragile sheets, which are damaged in the case when a sheet is vacuumed onto suction belt 263B, accommodating section 230 is drawn out. Further, the predetermined types of sheets include recording sheets exhibiting high rigidity, which damage suction sensor 211, while said sheet has been vacuumed onto suction belt 263B.

Accordingly, if recording sheets, exhibiting low rigidity, are used, that is, suction sensor 211 is not damaged by the rigidity of the sheet which has been vacuumed onto suction belt 263B, and if no problem occurs even though said sheet is damaged, then the above described controls of the suction detection and the allowance and prohibition of the drawing out operation of accommodating section 230 cannot be necessary to be conducted.

In this case, control section 101 judges information of the recording sheets, accommodated in each accommodating section 230, and further judges set information whether control of the present embodiment is necessary, whereby control section 101 determines whether the control of the present embodiment is to be conducted or not.

Due to control based on the type of recording sheet, the waiting time, concerning the allowance of drawing out accommodating section 230, can be reduced.

Further, in the case that plural sensors have been arranged as sheet suction sensor 211, since a recording sheet exhibiting large weight tends to drop quickly, it may be possible to determine that no sheet has been vacuumed. Still further, in the case that plural sensors have been arranged as sheet suction sensor 211, if the detected results vary among the plural sensors, since a recording sheet, such as an OHP sheet, exhibits high static adhesion, said sheet tends not to drop, so that it may be possible to determine that a sheet is vacuumed. Accordingly, if the detected results of plural suction sensors 211 vary among the plural sensors, it is preferable to change the determination, based on the weight of recording sheets, the surface condition of recording sheets, and the material of recording sheets.

Structure (1) As a structure, other than the above described structure, the above described one has control section 101 in image forming apparatus 100, and control section 201 in sheet supplying device 200. However, a control section of either image forming apparatus 100 or sheet supplying device 200 is configured to control both image forming apparatus 100 and sheet supplying device 200 in structure (1).

Structure (2), as a structure, other than the above structure, the recording sheet is vacuumed by air in the suction conveying section in the above structure. However, a suction conveying section can be configured to use a force other than that of vacuumed air, showing preferable results as structure (2).

Structure (3) The recording sheets, having been cut to a predetermined size, are used in the above structure. However, a rolled sheet can be vacuumed and conveyed, showing preferable results as structure (3).

Structure (4) Not only sheet supplying device 200, combined with image forming apparatus 100, to supply a large number of sheets, but also sheet supplying device 200, included in image forming apparatus 100, can be used as structure (4).

Structure (5) In the above structures, a sheet is vacuumed and conveyed to image forming apparatus 100. However, a sheet supplying device, which is configured to supply a sheet to various devices, can be structured as a sheet supplying device or as a sheet supplying system.

What is claimed is:

1. A sheet supplying device, comprising:
a sheet accommodating section which accommodates recording sheets, and is removable from a main body of the sheet supplying device;
a locking section which locks the sheet accommodating section within the main body of the sheet supplying device, not to draw out the sheet accommodating section from the main body of the sheet supplying device;
a suction conveying section which vacuums the recording sheet accommodated in the sheet accommodating section and conveys the recording sheet; and
a suction detecting section which detects the recording sheet which has been vacuumed by the suction conveying section,
wherein when the suction conveying section has supplied the recording sheet, if the suction detecting sensor detects the recording sheet, the locking section locks the sheet accommodating section within the main body of the sheet supplying device, and if the suction detecting sensor does not detect the recording sheet, the locking section releases the sheet accommodating section from the main body of the sheet supplying device.

2. The sheet supplying device of claim 1, wherein the locking section locks the sheet accommodating section within the main body of the sheet supplying device, only when the recording sheet, detected by the suction detecting sensor, is a predetermined type of the sheet.

3. Sheet supplying device of claim 1, further comprising plural suction detecting sensors,
wherein the locking section releases the sheet accommodating section, when one of the plural suction detecting sensors does not detect the recording sheet.

4. The sheet supplying device of claim 1, further comprising a display section which displays various conditions of the sheet supplying device,
wherein the display section displays that the sheet accommodating section is under a locked condition, when the locking section has locked the sheet accommodating section.

5. The sheet supplying device of claim 1, wherein the display section displays a reason why the sheet accommodating section is locked, when the locking section has locked the sheet accommodating section.

6. An image forming apparatus, comprising:
a sheet supplying device, comprising:
a sheet accommodating section which accommodates recording sheets, and is removable from a main body of the sheet supplying device;
a locking section which locks the sheet accommodating section within the main body of the sheet supplying device, not to draw out the sheet accommodating section from the main body of the sheet supplying device;
a suction conveying section which vacuums the recording sheet accommodated in the sheet accommodating section and conveys the recording sheet; and
a suction detecting section which detects the recording sheet which has been vacuumed by the suction conveying section,
wherein when the suction conveying section has supplied the sheet, if the suction detecting sensor detects the recording sheet, the locking section locks the sheet accommodating section within the main body of the sheet supplying device, and if the suction detecting sensor does not detect the recording sheet, the locking section releases the sheet accommodating section from the main body of the sheet supplying device; and
an image forming section which forms an image on the recording sheet which has supplied from the sheet supplying device.

7. An image forming system, comprising:
an image forming apparatus which forms an image on a recording sheet;
a sheet supplying device which supplies the recording sheet to the image forming apparatus; and
a control section which controls various sections,
wherein the sheet supplying device comprises:
a locking section which locks the sheet accommodating section within the main body of the sheet supplying device, not to draw out the sheet accommodating section from the main body of the sheet supplying device;
a suction conveying section which vacuums the recording sheet accommodated in the sheet accommodating section and conveys the recording sheet; and
a suction detecting section which detects the recording sheet which has been vacuumed by the suction conveying section,
wherein the control section controls the locking section in such ways that when the image formation has been completed, if the suction detecting sensor detects the recording sheet, the locking section locks the sheet accommodating section within the main body of the sheet supplying device, and if the suction detecting sensor does not detect the recording sheet, the locking section releases the sheet accommodating section from the main body of the sheet supplying device.

8. The image forming system of claim 7, wherein the control section locks the sheet accommodating section within the main body of the sheet supplying device, only when the recording sheet, detected by the suction detecting sensor, is a predetermined type of the sheet.

9. The image forming system of claim 7, further comprising plural suction detecting sensors,
wherein the locking section releases the sheet accommodating section, when one of the plural suction detecting sensors does not detect the recording sheet.

10. The image forming system of claim 7, further comprising a display section which displays various conditions of the sheet supplying device,
wherein the display section displays that the sheet accommodating section is under a locked condition, when the locking section has locked the sheet accommodating section.

11. The image forming system of claim 10,
wherein the display section displays a reason why the sheet accommodating section is locked, when the locking section has locked the sheet accommodating section.
